(19) United States
(12) Patent Application Publication
(10) Pub. No.: US 2026/0105612 A1
(43) Pub. Date: Apr. 16, 2026

(54) System and Method for Object Tracking and Determining Nearness Between Cameras

(71) Applicant: Eagle Eye Networks, Inc., Austin, TX (US)

(72) Inventors: Dean Drako, Austin, TX (US); Steven Roskowski, Austin, TX (US); Navaneethan Sundaramoorthy, Peelamedu (IN); Sankaranarayanan Parameswaran, Bangalore (IN)

(73) Assignee: Eagle Eye Networks, Inc., Austin, TX (US)

(21) Appl. No.: 18/915,755

(22) Filed: Oct. 15, 2024

(51) Int. Cl. G06T 7/20; G06V 10/74

(52) U.S. Cl. CPC G06T 7/20; G06V 10/761

(57) ABSTRACT

Embodiments for object tracking and determining camera nearness may monitor video streams from a plurality of cameras. When motion is detected in a first video stream, embodiments may monitor additional video streams. If embodiments detect motion in another video stream, embodiments may compare object characteristics to see if the two objects are the same. If the two objects are substantially the same and captured in video streams within a small time period, embodiments may determine the two objects are the same object, and may further determine whether the two cameras are near each other. Furthermore, object tracking may be analyzed to identify individual trends (habits) or collective trends.

### BACKGROUND

### Field of the Disclosure

The present invention relates to video surveillance and object tracking, and more particularly to systems and methods for tracking objects in multiple camera fields of view and determining camera nearness based on the same.

### Description of the Related Art

Cameras may be located at a site to capture sequences of frames as part of a video stream. Each video stream may capture a video stream of an object moving into, through, or away from the site.

### SUMMARY

Embodiments disclosed herein may be directed to a method for object tracking across video frames. In one or more embodiments, the method comprises: receiving a first video stream from a first camera at a first site; determining a first object is moving in the first video stream; determining a first set of object characteristics for the first object; receiving a second video stream from a second camera at a second site; determining a second object is moving in the second video stream; determining a second set of object characteristics for the second object; and determining, based on the first set of object characteristics matching the second set of object characteristics, that the first object and the second object are the same object. In some embodiments, determining a first set of object characteristics for the first object comprises: determining a direction of movement of the first object in the first video stream; determining a second set of object characteristics for the second object comprises determining a direction of movement of the second object in the second video stream; and determining, based on the direction of movement of the first object in the first video stream and the direction of movement of the second object in the second video stream, that the first object and the second object are the same object. In some embodiments, determining a first set of object characteristics for the first object comprises: determining a speed of the first object in the first video stream; determining a second set of object characteristics for the second object comprises determining a speed of the second object in the second video stream; and determining, based on the speed of the first object exiting from the first video stream and the speed of the second object entering the second video stream, that the first object and the second object are the same object. In some embodiments, the method further comprises determining a distance between the first site and the second site; and determining, based on one or more of the speed of the first object, the speed of the second object and the distance between the first site and the second site, that the first object and the second object are the same object. In some embodiments, the method further comprises determining a first camera direction for the first camera; determining a second camera direction for the second camera; and determining, based on one or more of the direction of travel of the first object relative to the first camera direction, the direction of travel of the second object relative to the second camera direction and the distance between the first site and the second site, that the first object and the second object are the same object.

Embodiments disclosed herein may be directed to a system for object tracking across video frames, the system comprising: a first bridge, a second bridge and a data center. The first bridge comprises: a first memory storing a first set of instructions; and a first processor configured to execute the first set of instructions to: receive a first video stream from a first camera at a first site; determine a first object is moving in the first video stream; determine a first set of object characteristics for the first object; and communicate the first video stream to a data center. The second bridge comprises: a second memory storing a second set of instructions; and a second processor configured to execute the second set of instructions to: receive a second video stream from a second camera at a second site; determine a second object is moving in the second video stream; determine a second set of object characteristics for the second object; and communicate the second video stream to the data center. The data center comprises: a third memory storing a third set of instructions; and a third processor configured to execute the third set of instructions to: receive the first video stream and the second video stream; and determine, based on the first object moving, the second object moving, the first set of object characteristics and the second set of object characteristics, that the first object and the second object are the same object. In some embodiments, one or more of the first processor and the third processor is configured to determine a direction of movement of the first object in the first video stream; one or more of the second processor and the third processor is configured to determine a direction of movement of the second object in the second video stream; and the third processor is configured to determine, based on the direction of movement of the first object in the first video stream and the direction of movement of the second object in the second video stream, that the first object and the second object are the same object. In some embodiments, the third processor is configured to determine, based on a time between the first object exiting from the first video stream and the second object entering the second video stream, that the first object and the second object are the same object. In some embodiments, one or more of the first processor and the third processor is configured to determine a speed of the first object; one or more of the second processor and the third processor is configured to determine a speed of the second object; and the third processor is configured to determine, based on one or more of the speed of the first object and the speed of the second object, that the first object and the second object are the same object. In some embodiments, the third processor is configured to: determine a distance between the first site and the second site; and determine, based on one or more of the speed of the first object, the speed of the second object and the distance between the first site and the second site, that the first object and the second object are the same object. In some embodiments, one or more of the first processor and the third processor is configured to determine a first camera direction for the first camera; one or more of the second processor and the third processor is configured to determine a second camera direction for the second camera; and the third processor is configured to determine, based on one or more of the direction of travel of the first object relative to the first camera direction, the direction of travel of the second object relative to the second camera direction and the distance between the first site and the second site, that the first object and the second object are the same object.

Embodiments disclosed herein may be directed to a method for determining camera nearness, the method comprising: receiving a first video stream from a first camera at a first site; determining a first object is moving in the first video stream; determine a first set of object characteristics for the first object; receiving a second video stream from a second camera at a second site; determining a second object is moving in the second video stream; determining a second set of object characteristics for the second object; determining the first object and the second object are the same object; and determining a nearness between the first site and the second site based on the first object being the same object as the second object and a time between the first object exiting the first video stream and the second object entering the second video stream. In some embodiments, the method comprises determining a direction of movement of the first object in the first video stream; determining a direction of movement of the second object in the second video stream; and determining the nearness between the first site and the second site based on the direction of movement of the first object in the first video stream and the direction of movement of the second object in the second video stream. In some embodiments, the method comprises determining, based on a time between the first object exiting from the first video stream and the second object entering the second video stream, that the first object and the second object are the same object. In some embodiments, the method comprises determining a speed of the first object; determining a speed of the second object; and determining, based on one or more of the speed of the first object and the speed of the second object, that the first object and the second object are the same object. In some embodiments, the method comprises determining a distance between the first site and the second site; and determining, based on one or more of the speed of the first object, the speed of the second object and the distance between the first site and the second site, that the first object and the second object are the same object. In some embodiments, the method comprises determining a first camera direction for the first camera; determining a second camera direction for the second camera; and determining, based on one or more of the direction of travel of the first object relative to the first camera direction, the direction of travel of the second object relative to the second camera direction and the distance between the first site and the second site, that the first object and the second object are the same object.

To further clarify the above and other advantages and features of the present invention, a more particular description of the invention will be rendered by reference to specific embodiments thereof that are illustrated in the appended drawings.

### BRIEF DESCRIPTION OF DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts a system architecture of one embodiment of a network for video surveillance;

FIGS. 2-7 depict embodiments of user systems for video surveillance;

FIG. 8 depicts an architecture diagram of one embodiment of a system for object tracking and/or determining nearness between cameras;

FIG. 9 depicts a map, illustrating locations and orientations for a plurality of cameras relative to streets, driveways, buildings and areas;

FIG. 10 is a flow diagram, illustrating one embodiment of a method for object tracking and/or determining camera nearness;

FIG. 11 is a flow diagram, illustrating one embodiment of a method for individual and collective trend analyses; and

FIG. 12 is a diagram of an information handling system configurable for processing and storing information from devices associated with user locations.

### DETAILED DESCRIPTION OF THE INVENTION

In the following description, details are set forth by way of example to facilitate discussion of the disclosed subject matter. It should be apparent to a person of ordinary skill in the field, however, that the disclosed embodiments are exemplary and not exhaustive of all possible embodiments.

As used herein, a reference numeral refers to a class or type of entity, and any letter or hyphenated numeral following such reference numeral refers to a specific instance of a particular entity of that class or type. Thus, for example, a hypothetical entity referenced by ‘12A’ or ‘12-1’ may refer to a particular instance of a particular class/type, and the reference ‘12’ may refer to a collection of instances belonging to that class/type or any one instance of that class/type in general.

As used herein, the term “or” refers to an inclusive or, wherein the statement is true if either option or both options are true. Thus, the statement “A or B is true” is true if either A or B is true and is also true if both A and B are true.

### Overview-video Surveillance Systems

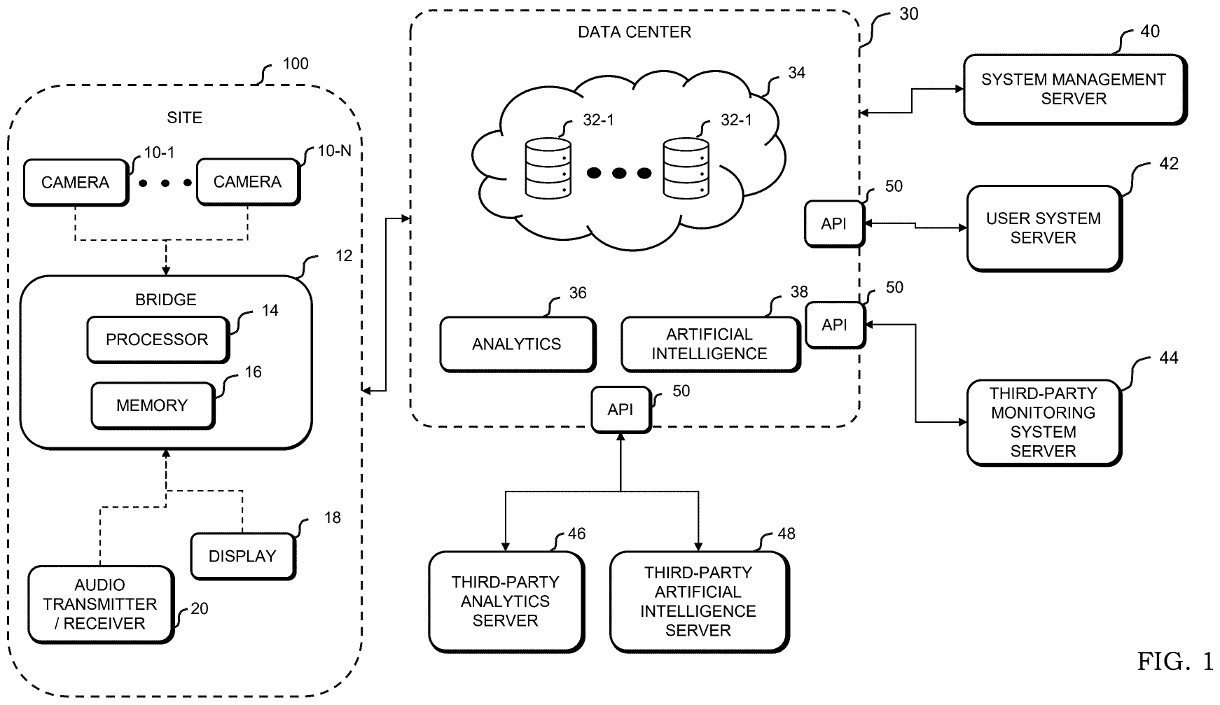

FIG. 1 depicts a system architecture of one embodiment of a video surveillance system for monitoring site 100 and communicating a plurality of video frames (i.e., a video stream) from site 100 to data center 30. Site 100 may refer to a building, structure, and/or an area, any of which may include a plurality of buildings, structures, and/or areas. Data center 30 may also communicate with video surveillance control system 40, user system server 42, third-party monitoring system server 44, third party analytics server 46 and/or third-party artificial intelligence server 48.

### Cameras

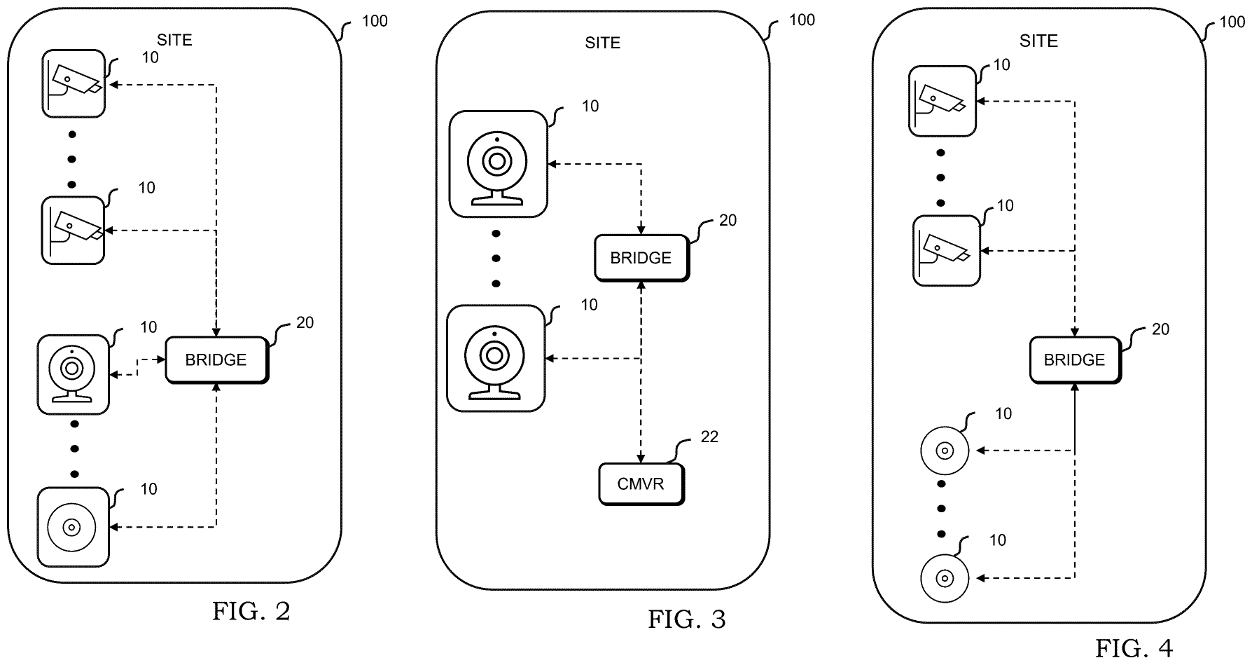

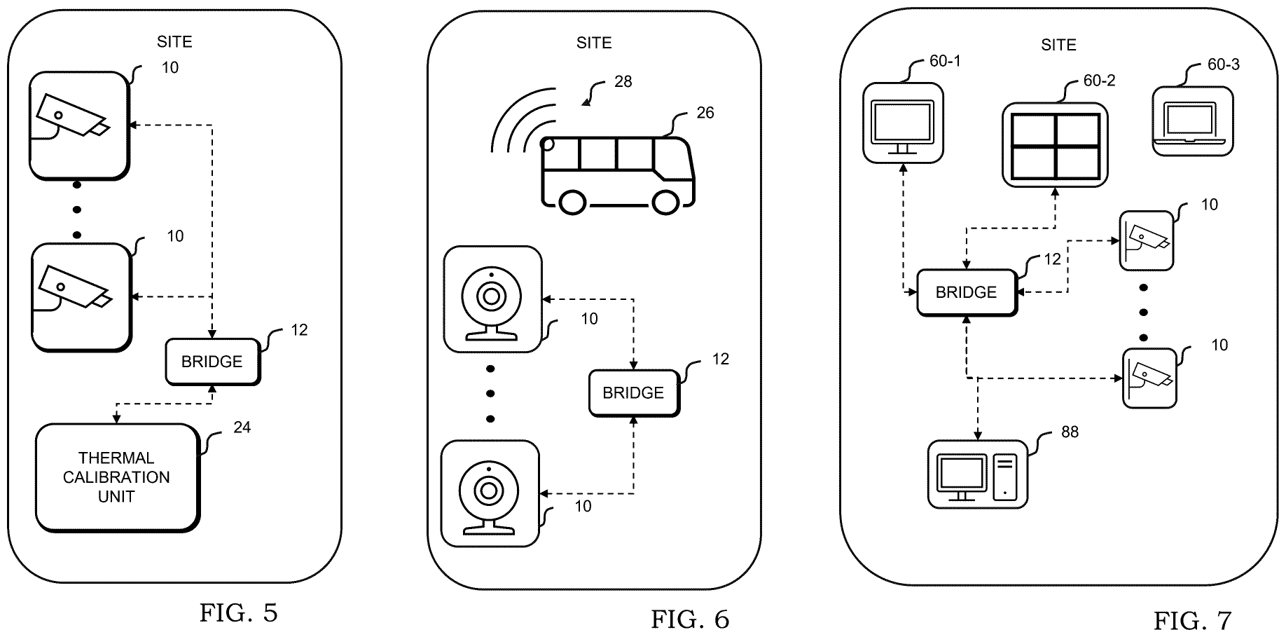

Referring to one or more of FIGS. 2-7, cameras 10 may comprise analog or digital (e.g., Internet Protocol or “IP”) cameras 10 including, but not limited to, directional cameras 10, 360-degree cameras 10, fish-eye cameras 10, black-and-white video cameras 10, color cameras 10, high-resolution cameras 10, low-resolution cameras 10 or infrared cameras 10 for capturing video information. One or more cameras 10 may comprise proprietary cameras 10 associated with Eagle Eye Networks, Inc. of Austin, Texas or may be manufactured by a third-party enterprise. A camera 10 may be located inside or outside a structure (e.g., an office building, a school, a warehouse), in a structure (e.g., parking garages and other structures not fully enclosed but providing some of the benefits of being indoors) or near an area (e.g., near elevators or an entrance to a building, near a playground, in a park, in a parking lot), discussed in greater detail below. Referring to FIG. 6, in some embodiments, cameras 10 or bridge 20 may be located in vehicle 26 with mobile network device 28 configured to communicate with data center 30 over a network (e.g., cellular or Wi-Fi), wherein vehicle 26 may be considered a site 100.

### Bridges Perform Lightweight Processing of Video Streams On-Site

Constantly communicating (i.e., “streaming”) a video stream from each camera 10 to data center 30 for processing would depend on, among other things, network bandwidth. Processing all video streams on-site would require significant processing resources. Embodiments disclosed herein may include a bridge 12 at each site 100, wherein bridge 12 may be an edge device (e.g., an entry point for images and data from the physical world) configured for lightweight processing of video streams. Site 100 may further include display 18 for communicating video information to a user and audio transmitter/receiver 20 for communicating audio information to or from a user.

As used herein, the term “lightweight” may refer to basic processing of individual video streams, including, but not limited to capturing a video stream, applying a timestamp, and communicating the video stream to data center 30. Lightweight processing may further comprise object identification (e.g., vehicle recognition, license plate recognition (LPR)) and characteristic determination (e.g., determining a size characteristic or nearness of an object, determining a speed characteristic, determining a number of objects, etc.) within a video stream.

Bridge 12 may execute instructions to communicate video streams and information to data center 30. Information communicated to data center 30 may include, for example, a time stamp or information about camera 10 associated with the information. In some embodiments, bridge 12 may:
receive video streams and information from one or more cameras 10 and directly communicate the video streams and information to data center 30;
receive video streams and information from one or more cameras 10 and analyze or process at least a portion of the video streams and information before communicating the video streams and information to data center 30; and/or
receive video streams and information from one or more cameras 10 and store at least a portion of the video streams and information before communicating the video streams and information to data center 30.

Thus, communicatively coupling cameras 10 to bridges 12 and communicatively coupling bridges 12 to data center 30 may refer to directly or indirectly communicating video streams and information from cameras 10 to data center 30, communicating video streams and information from cameras 10 through bridges 12 to data center 30, and/or analyzing, processing or storing at least a portion of the video streams and information before communicating the video streams and information to data center 30. Embodiments of bridge 12 may be configured to communicate video streams and information to data center 30 in real-time, periodically (e.g., at scheduled intervals or at a scheduled time), or based on an event (e.g., in response to a predefined trigger). In some embodiments, bridge 12 may communicate a video stream to data center 30 when bridge 12 detects motion and determines an object is present. In some embodiments, bridge 12 may communicate a video stream to data center 30 when bridge 12 detects motion and determines an object is present and identifies the object. In some embodiments, bridge 12 may communicate a video stream to data center 30 when bridge 12 detects motion and determines an object is present, identifies the object and determines a set of object characteristics.

Memory 16 may store video information including one or more video streams, information about the video streams (e.g., timestamps), and information about the cameras 10 (e.g., information about a site 100 at which camera 10 is located, a location of camera 10 at site 100, a direction in which each camera 10 is aimed, etc.).

### Data Centers

Data center 30 may refer to a plurality of servers 32 or other information handling systems configured for processing video streams for smart video surveillance and storing information including video streams, analytics on video streams and data associated with video streams. Data center 30 may be located at a single location or may be located at a collection of locations (e.g., a “cloud” system 34) such that video streams and other information received from hundreds or even thousands of cameras 10 may be received, processed, stored, and accessed as needed. Data center 30 may be communicatively coupled to system management server 40, one or more user system servers 42 and one or more third-party monitoring system servers 44. Data center 30 may also be communicatively coupled to third party analytics server 46 and/or third-party artificial intelligence (AI) server 48. User system servers 42, third-party monitoring system servers 44, third-party analytics servers 46 and third-party AI servers 48 may be communicatively coupled to data center 30 through Application Programming Interfaces (APIs) 50.

User system server 42 may refer to an information handling system having a processor and memory storing a set of instructions executable by the processor to allow a user associated with site 100 to access video streams and video information about site 100, configure permissions for cameras 10 and memory 16 located on-site, etc.

Third-party monitoring system server 44 may refer to an information handling system having a processor and memory storing a set of instructions executable by the processor to allow a user with a third-party monitoring system server 44 to view and/or access video streams. An API 50 for third-party monitoring system server 44 may be instantiated specifically for third-party monitoring system server 44 and therefore may be different than other APIs 50 for user system server 42, third-party analytics 46 or third-party artificial intelligence systems 48.

Third-party analytics server 46 may refer to an information handling system having a processor and memory storing a set of instructions executable by the processor to allow a user with a third-party analytics server 46 to analyze content in video streams. API 50 for third-party analytics server 46 may be instantiated specifically for the third-party analytics server 46 and therefore may be different than other APIs 50 for user system server 42, third-party monitoring system server 44 or third-party artificial intelligence systems 170.

Third-party artificial intelligence (AI) server 48 may refer to an information handling system having a processor and memory storing a set of instructions executable by the processor to analyze content in video streams. API 50 for third-party artificial intelligence systems 48 may be instantiated specifically for third-party artificial intelligence systems 48 and therefore may be different than other APIs 50 for user system server 42, third-party monitoring system server 44 or third-party analytics server 46.

### Multiple Cameras (including Different Camera Types) May Be Associated With a Site

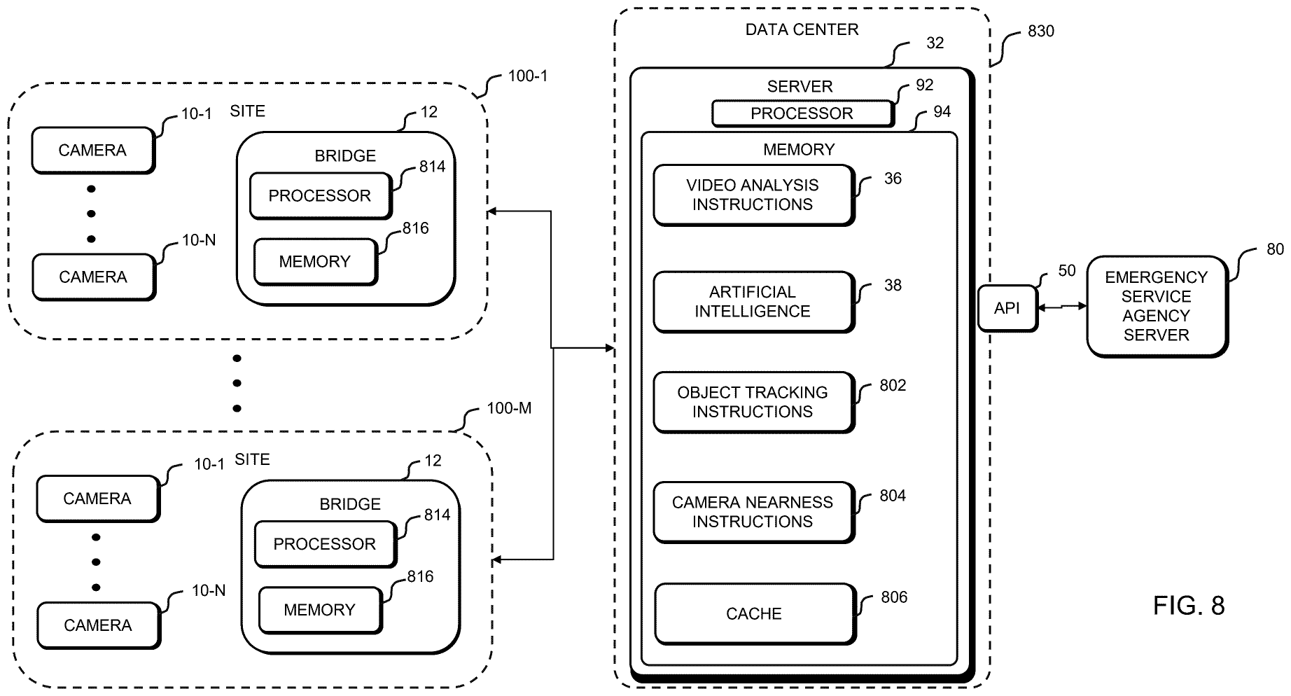

Turning to FIG. 8, embodiments of systems disclosed herein may comprise servers 32 in data center 830 configured to analyze video streams received from cameras 10, wherein the cameras 10 may be made by different manufacturers and have different specifications and capabilities, and wherein the exact location and/or orientation of each camera 10 is not available to data center 830 (or may be incorrect). Embodiments of a video surveillance system may identify an object in a first video stream, identify an object in a second video stream and determine the two objects are the same object. Embodiments may further track the object as it enters/exits cameras'fields of view and determine camera nearness between two cameras (e.g., how close a first camera 10 is relative to a second camera 10). Embodiments may identify a trend corresponding to a single object (e.g., an individual trend or habit) or a trend for multiple objects (e.g., a collective trend).

Data center 830 may comprise a plurality of servers 32 configured for determining camera nearness and tracking objects traveling into, through, and away from a site 100 or multiple sites 100 (and therefore into, through and out of multiple fields of view). Each server 32 may comprise processor 92 executing a set of video analysis instructions 36, artificial intelligence instructions 38, object tracking instructions 802 and/or camera nearness instructions 804 stored in memory 94 to analyze video streams to track objects relative to one or more sites 100, determine camera nearness, identify an individual trend (habit) or determine a collective trend. Memory 94 may also include cache 806, discussed in greater detail below.

### Information Processing for Smart Video Surveillance

In some embodiments, information processing may comprise analyzing information from one or more cameras 10. For example, information may include determining a manufacturer of camera 10, an accuracy of camera 10, a minimum threshold (e.g., minimum sound level, illumination or temperature) associated with camera 10, a maximum threshold (e.g., maximum temperature, sound level or illumination) associated with camera 10, a resolution of camera 10, a frame per second (FPS) processing speed of camera 10, a latency of camera 10, a transmission protocol, or some other information associated with the capabilities of camera 10 for recording and transmitting information. Information may also include, for example, information on a location of camera 10, wherein location information may include absolute information (e.g., geo-positioning system or GPS information) and/or relative location information (e.g., “the north stairwell”). Information may include, for example, azimuth or orientation information, wherein orientation information may comprise absolute information (e.g., angled at 45 degrees horizontally and −25 degrees vertically) and/or relative information (e.g., “angled towards the stairwell and looking down”). Information may include, for example, a time, a date, and/or other information to identify where and when information was captured. Information may include network information, such as an Internet Protocol (IP) address and/or an alias (e.g., “the main lobby camera”). In the event the location and/or orientation of cameras 10 is not available, embodiments may still identify an object associated with two cameras 10 and determine camera nearness. Furthermore, even if the locations of two cameras 10 indicate they are geographically near each other, embodiments may determine they are not logically near each other.

### Video Stream Processing for Smart Video Surveillance

Video stream processing for smart video surveillance may include, but is not limited to, receiving a video stream from a camera 10 at a site 100, identifying an object in the video stream, determining a set of characteristics associated with the object in the video stream and analyzing other video streams to determine when the object enters a field of view for a second camera 10, which may be located at the same site 100 or a different site 100. Processing a video stream for smart video surveillance may also include applying artificial intelligence for advanced analyses including tracking an object entering/exiting multiple fields of view, trend analysis and anomaly detection, as well as predictions and/or decision making. Trend analysis may include determining a trend that is unique to a single object (e.g., an individual trend or habit) and/or determining a trend that is generic to a plurality of objects (e.g., a collective trend). Anomaly detection may include determining when an object behaves in a way atypical to an expected trend (e.g., a person going around a building instead of a typical individual trend or expected trend of going through the building), determining when an object behaves in a way atypical to a collective trend (e.g., a person going around a building when other people go through the building, a vehicle drives off road when other vehicles drive on a road, a piece of luggage remains in a cart when a typical collective trend is that all pieces of luggage are unloaded, etc.) and determining when objects behave in a way atypical to a collective trend (e.g., a group of people typically go to an elevator but all are exiting the building using the stairs, all vehicles turn off a road instead of traveling on the road, all vehicles are moving at a slower speed, etc.).

### Object Tracking, Determining Camera Nearness and Trend Analyses-Overview

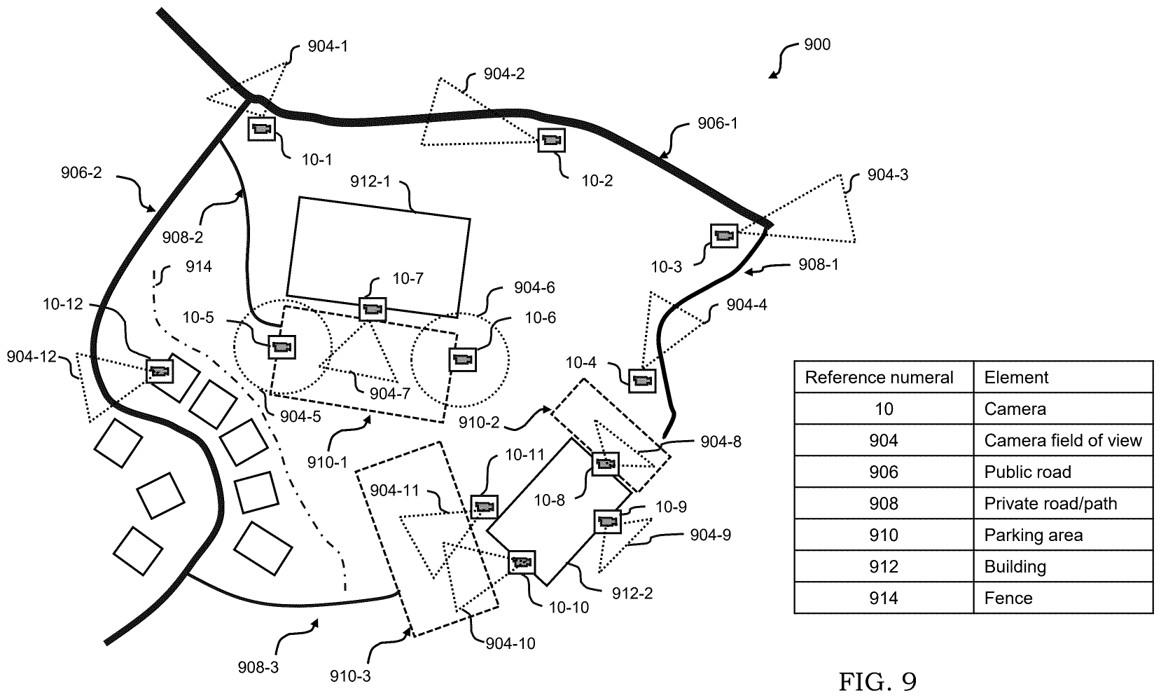

FIG. 9 depicts a map 900 depicting: a plurality of cameras 10, each camera 10 having a field of view 904. Map 900 further depicts public roads 906, private roads 908 (which may include paths or trails), areas 910 (including parking lots), buildings 912 and fences 914. As illustrated in FIG. 9, cameras 10 are not evenly spaced, are not all oriented in the same direction, and their respective fields of views 904 are not the same size. Furthermore, the position of each camera 10 on map 900 may be an approximation of where each camera 10 is positioned and each field of view 904 may be an approximation of an actual field of view. As depicted in FIG. 9, in some embodiments, map 900 may correspond to an outdoor area, wherein the location of each camera 10 may be an approximation of the coordinates of the camera 10. In other embodiments, map 900 may correspond to a building or structure, wherein the location of each camera 10 may be an approximation of the location of the camera 10 relative to a floorplan.

### Object Tracking

As used herein, the term “object” may refer to anything capable of movement or being moved. Thus, objects may include a person or persons, who may be capable of movement by walking, running, or swimming, as well as cycling, rowing, and other human-powered objects. Objects may further include vehicles including e-bikes, mopeds, motorcycles, cars, vans, trucks, and other modes of transportation for people and other objects. Objects may also include transportable or portable objects, including hand-held objects. Thus, a semi-truck may be considered an object, and may also transport containers, pallets and other objects (e.g., an automobile transport transports automobiles). A car may transport objects (e.g., people, animals, objects like luggage and parcels). A person may transport hand-held objects (e.g., a cell phone, purse, etc.). Embodiments disclosed herein may identify a first object (e.g., including a person or persons, an animal or animals and a vehicle or vehicles) in a first video stream, identify a second object in a second video stream and determine the first object and the second object are the same object.

Still referring to FIG. 9, if an object (e.g., a vehicle) is traveling along road 906-1 and enters field of view 904-1, camera 10-1 may capture a video stream of the object, wherein a bridge 12 associated with camera 10-1 may determine there is motion in the video stream, perform lightweight processing (e.g., identifying the object, determining a set of object characteristics, etc.) and communicate the video stream, object information (e.g., a license plate number), and the set of object characteristics to data center 30.

The object may continue through and exit field of view 904-1 and 1) continue traveling on road 906-1 towards field of view 904-2 associated with camera 10-2; or 2) turn onto road 906-2 towards field of view 904-12 associated with camera 10-12. Bridge 12 associated with camera 10-2 or camera 10-12 may determine there is motion in the video stream, perform lightweight processing (e.g., identifying the object, determining a set of object characteristics, etc.) and communicate the video stream, object information (e.g., a license plate number), and a set of object characteristics to data center 30. Servers 32 at data center 30 may analyze the two video streams, time stamp information associated with each video stream, object information and the two sets of object characteristics and determine the objects in the two video streams are the same object. Server 32 may further store one or more video streams, one or more images of either or both data streams, object information and a set of object characteristics for further analyses related to the individual object (e.g., determining if the object follows the same path every day as an individual trend or habit) or analyses related to the individual as part of a group (e.g., determining if the object is one of a plurality of similar objects that follow the same path, indicating a collective trend).

### Determining Camera Nearness

Still referring to FIG. 9, even though a distance between camera 10-1 and camera 10-2 may be the same as a distance between camera 10-1 and camera 10-12, road 906-1 may have a higher speed limit such that a time for some objects (e.g., a vehicle) to exit field of view 904-1 and enter field of view 904-2 may be less than a time for the object to exit field of view 904-1 and enter field of view 904-12. Notably, if the object is a person riding a bicycle, a time for the person to exit field of view 904-1 and enter field of view 904-2 may be longer than the time for a vehicle to travel along the same route, and a person walking along road 906-1 may take even longer. However, a person walking may take about the same amount of time to exit field of view 904-1 and enter field of view 904-2 as it takes the person to exit field of view 904-1 and enter field of view 904-12. Thus, determining camera nearness may include identifying an object in a video stream and determining an object speed as an object characteristic, wherein servers 32 may use the object speed for determining or refining camera nearness.

Referring to cameras 10-2, 10-3 and 10-4 and their corresponding fields of view 904-2, 904-3 and 904-4, vehicles traveling along road 906-1 from right to left (relative to the page), may enter field of view 904-3 and either 1) continue on public road 906-1 towards field of view 904-2 associated with camera 10-2 or 2) turn onto private road 908-1 towards field of view 904-4 associated with camera 10-4. Vehicles may be capable of traveling at a higher speed on road 906-1 than on road 908-1, but the orientation of camera 10-4 relative to road 908-1 differs from the orientation of camera 10-2 relative to road 906-1. As a result, a vehicle traveling on road 908-1 may enter field of view 904-4 much earlier than a vehicle traveling on road 906-1 may enter field of view 904-2.

Referring to cameras 10-5, 10-6 and 10-7 and their corresponding fields of view 904-5, 904-6 and 904-7, a camera 10 may be positioned relative to a parking lot 910 and/or a building 912 such that objects typically captured by video streams include vehicles and people and may also include animals or other types of objects. Furthermore, fields of view 904-5 and 904-7 are depicted as overlapping, whereas field of view 904-6 does not overlap any other field of view 904. Thus, an object may be detected in both fields of view 904-5 and 904-7, allowing for easier determination the two objects are the same object, but an object exiting field of view 904-7 might not enter field of view 904-6 for a few seconds.

Referring to cameras 10-8, 10-9, 10-10 and 10-11 and their corresponding fields of view 904-8, 904-9, 904-10 and 904-11, cameras 10 may be positioned relative to an area (e.g., a parking lot) 910-2 or 910-3 or a building 912-2 such that objects include vehicles and people (and possibly animals or other types of objects). Furthermore, building 912-2 may affect the timing between when an object exits a field of view 904 and enters another field of view 904. For example, a person may walk through or around building 912-2, wherein the person may exit field of view 904-8 and 1) go through building 912-2 to enter field of view 904-10, 2) travel clockwise around building 912-2 through field of view 904-9 to enter field of view 904-10, or 3) travel counterclockwise around building 912-2 through field of view 904-11 to enter field of view 904-10. Thus, the amount of time for the person to exit field of view 904-8 and enter field of view 904-10 depends on the speed that the person is walking and the direction of travel (or path). Notably, a vehicle in parking lot 910-2 might not be able to travel directly to parking lot 910-3. Thus, camera 10-8 may be considered near to cameras 10-9, 10-10 and 10-11 if the object is a person, but not if the object is a vehicle.

Referring to cameras 10-5 and 10-12 and their corresponding fields of view 904-5 and 904-12, cameras 10 may be positioned close geographically, but a barrier such as fence 914 may be located such that objects including vehicles and people may be prevented from quickly passing between fields of view 904-5 and 904-12, but animals might be capable of quickly passing between fields of view 904-5 and 904-12.

Thus, determining whether a camera 10 is near another camera 10 may involve identifying the type of object (e.g., vehicle, person or animal), determining object characteristics (e.g., how fast the object is traveling, is capable of traveling or a typical speed), determining a direction of travel (including a path) and other characteristics. For example, embodiments may use these and other object characteristics to determine a cache time as a range of time that the object would be expected to exit an Nth (e.g., first) field of view 904 and enter an Nth+1 (e.g., second) field of view. If the object characteristics for an Nth (e.g., first) object exiting a field of view 904 of one camera 10 substantially match the object characteristics for an Nth+1 (e.g., second) object entering a field of view 904 of another camera 10 and within a time period (e.g., a cache time), embodiments may determine the two objects are the same object, determine the two cameras 10 are near each other and track the object. Furthermore, embodiments may, over time and with repeated events, refine the cache time between the two cameras 10 to better predict when objects leaving one field of view 904 would be likely to enter the other field of view 904.

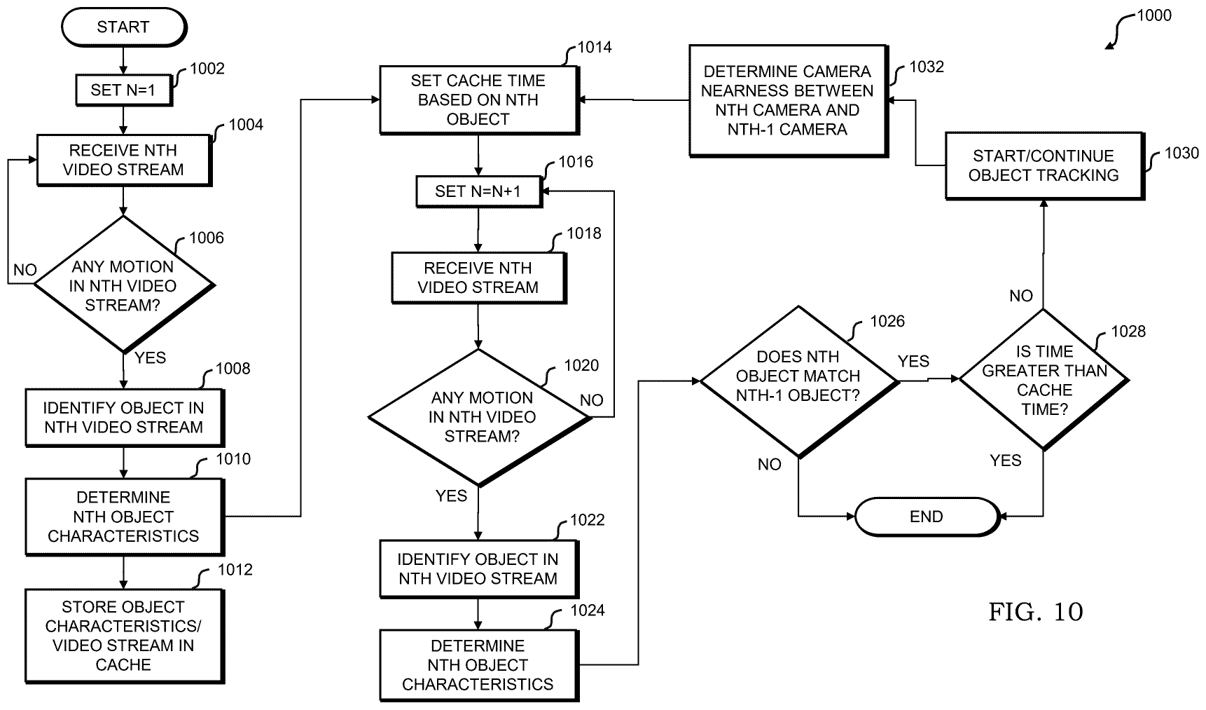

FIG. 10 depicts flow diagram 1000, illustrating a method for object tracking and/or determining camera nearness.

At step 1002, server 32 set N equal to 1.

At step 1004, server 32 receives the Nth (e.g., first) video stream from the Nth (e.g., first) camera 10 at an Nth (e.g., first) site 100.

At step 1006, server 32 determines if there is any motion in the Nth video stream. In some embodiments, bridges 12 may be configured to only send video streams when motion is detected. In these situations, the Nth video stream may be expected to contain motion.

If, at step 1006, server 32 determines there is not any motion in the Nth video stream, server 32 may continue analyzing the Nth video stream.

If, at step 1006, server 32 determines there is motion in the Nth (e.g., first) video stream, then at step 1008, server 32 identifies the object in the Nth (e.g., first) video stream. Identifying an object may comprise determining if the object is a person, an animal, or a vehicle. In some embodiments, identifying an object may comprise determining whether 1) the object is a child, a young adult, an adult or a senior adult; 2) the object is a domestic animal or a wild animal or the animal is a bird or a terrestrial animal; or 3) the vehicle is a bicycle (including an e-bike or pedelec), a motorcycle (including a scooter), an automobile, a truck, or some other type of motorized vehicle.

At step 1010, server 32 determines object characteristics for the Nth object. If the Nth object is a person, server 32 may determine, for example, a size of the person, information about the clothes that the person is wearing, a gait (including a gait speed), or a direction of travel. If the Nth object is a vehicle, server 32 may determine, for example, a size of the vehicle, a vehicle signature (e.g., color, a license plate, roof rack, bike rack, tire size, etc.), a speed, and/or a direction of travel. If the Nth object is an animal, server 32 may determine, for example, a size of the animal, whether the animal is a domesticated animal (e.g., a dog or cat) or a wild animal (e.g., a fox or coyote), a speed, and/or a direction of travel. Independent of other subsequent steps, server 32 may store information determined from steps 1004, 1006 and 1008 in memory 98.

Determining camera nearness and tracking an object ae both times dependent. For example, a first camera 10 may capture a first video stream of a white truck at a first time and a second camera 10 may capture a second video stream of a white truck at a second time. If the second time is within a short time, it is possible the two trucks are the same truck and therefore the two cameras may be near each other. However, if the second time is several hours later, it is likely that the first white truck is different from the second white truck or the first camera is not near the second camera. Embodiments disclosed herein may store object information in a cache for a period (e.g., a “cache time”) and compare objects in video streams that are within a cache time limit for object tracking and determining camera nearness.

At step 1012, embodiments may store the Nth (e.g., first) object characteristics (e.g., object type, object description, object speed, object direction of travel, etc.) in cache 806.

At step 1014, server 32 may set a cache time limit based on the Nth object, including based on the Nth object characteristics. For example, if the Nth object is a person, the cache time limit may be a first period (e.g., a minute) based on the speed that the person is traveling or the average speed that a human can walk or run. If the Nth object is an animal, the cache time limit may be a second period (e.g., 30-45 seconds) based on the speed that the animal is traveling or based on an average speed or range of speeds associated with the animal. The cache time limit may be shorter because animals are generally faster than humans, but it may also be longer based on the current speed of the animal (e.g., horses are capable of much faster speeds than humans, but they may be grazing and thus not moving quickly). If the Nth object is a vehicle, the cache time limit may be a third period (e.g., a few seconds) because of the speed of the vehicle or because a vehicle is capable of traveling at much higher speeds.

At step 1016, server 32 may increment N (e.g., increase the value of variable N to equal N+1).

At step 1018, server 32 may receive the Nth (e.g., second) video stream from the Nth (e.g., second) camera 10.

At step 1020, embodiments may determine if there is any motion in the Nth (e.g., second) video stream. In some embodiments, processor 14 in bridge 12 may determine if there is motion in the Nth (e.g., second) video stream.

If, at step 1020, processor 14 determines there is not any motion in the Nth (e.g., second) video stream, then server 32 may repeat steps 1016-1020 to analyze other video streams for motion.

If, at step 1020, processor 14 determines there is motion in the Nth (e.g., second) video stream, then at step 1022, embodiments may identify the object in the Nth (e.g., second) video stream. In some embodiments, processor 14 in bridge 12 executes instructions to identify the Nth (e.g., second) object. In some embodiments, processor 92 in server 32 may identify the object in the Nth (e.g., second) video stream.

At step 1024, embodiments may determine object characteristics for the Nth (e.g., second) object. In some embodiments, processor 14 in bridge 12 executes instructions to determine object characteristics for the Nth (e.g., second) object. In some embodiments, processor 92 in server 32 may determine object characteristics for the Nth (e.g., second) object.

At step 1026, embodiments may determine if the Nth (e.g., second) object is the same as an object (e.g., the first object) stored in cache 806. Determining if the Nth (e.g., second) object is the same as the object stored in cache 806 may comprise comparing object characteristics (e.g., object size, object appearance, object speed, object direction of travel, etc.).

If, at step 1026, embodiments determine the Nth (e.g., second) object is different from the object stored in cache 806 (e.g., the first object), embodiments may stop monitoring video streams.

If, at step 1026, embodiments determine the Nth (e.g., second) object is the same as the object stored in cache 806 (e.g., the first object), then at step 1028, embodiments determine if a time associated with the Nth (e.g., second) object entering the Nth (e.g., second) field of view 904 is greater than the cache time limit.

If, at step 1028, embodiments determine the time is greater than the cache time limit, then the process may end.

If, at step 1028, embodiments determine the time is not greater than the cache time limit, then, at step 1030, server 32 may start or continue object tracking. Object tracking may comprise storing information about the object and what route the object is traveling based on the object being identified in video streams from two or more cameras 10.

At step 1032, server 32 may determine a camera nearness between the Nth (e.g., second) camera 10 and the Nth−1 (e.g., first) camera 10. In some embodiments, determining a camera nearness may comprise determining one or more of a minimum time, a maximum time, an average time or a range of times for an object to travel from the Nth−1 (e.g., first) field of view 904 to the Nth (e.g., second) field of view. In some embodiments, determining a camera nearness may comprise determining a distance between the Nth−1 (e.g., first) field of view 904 and the Nth (e.g., second) field of view based on one or more of a minimum time, a maximum time, an average time or a range of times for an object to travel from the Nth−1 (e.g., first) field of view 904 to the Nth (e.g., second) field of view.

Steps 1014 to 1032 may be repeated each time an object is detected in a new field of view 904, wherein the process stops when embodiments determine either the time between objects appearing in fields of view 904 is too large and/or objects do not substantially match each other.

### Trend Analyses

Embodiments may store object information, a set of object characteristics, and other information to perform additional analyses for determining whether an object is behaving in a way typical for the individual object (e.g., a habit) and/or whether the object or a group of objects is behaving in a way typical for similar objects (e.g., a trend). For example, if a person exits building 912-2 and only walks through fields of view 904-8, 904-9 and 904-10, embodiments may determine that is a pattern for the person. If a plurality of people all exit building 912-2 and only walk through fields of view 904-8, 904-9 and 904-10, embodiments may determine either that is a pattern for people in general, that there is an obstacle preventing them from walking through field of view 904-11, etc. If a plurality of people all exit building 912-2 and mostly walk through fields of view 904-8, 904-9 and 904-10 and only above average-sized persons (e.g., males) or groups of people walk through field of view 904-11, embodiments may determine people may feel unsafe walking around the side of building 912-2 associated with field of view 904-11. Advantageously, embodiments may determine patterns for individual objects and object types.

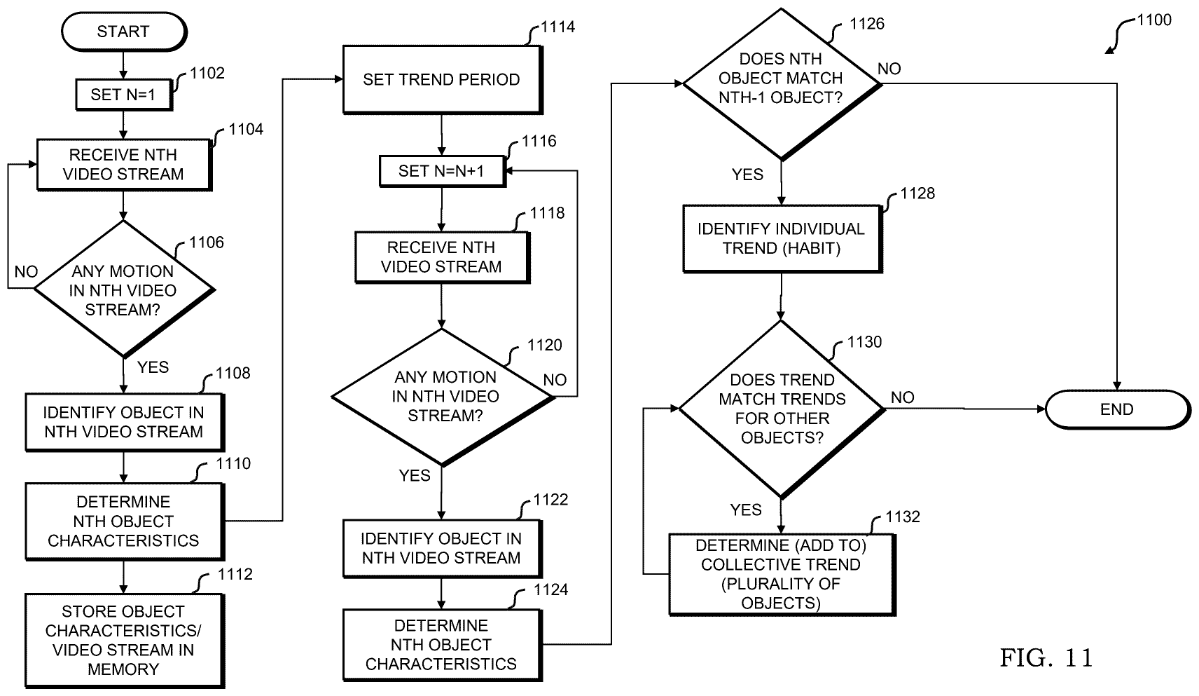

FIG. 11 depicts flow diagram 1100, illustrating a method for object tracking and/or determining camera nearness.

At step 1102, server 32 set N equal to 1.

At step 1104, server 32 receives the Nth (e.g., first) video stream from the Nth (e.g., first) camera 11 at an Nth (e.g., first) site 110.

At step 1106, server 32 determines if there is any motion in the Nth video stream. In some embodiments, bridges 12 may be configured to only send video streams when motion is detected. In these situations, the Nth video stream may be expected to contain motion.

If, at step 1106, server 32 determines there is not any motion in the Nth video stream, server 32 may continue analyzing the Nth video stream.

If, at step 1106, server 32 determines there is motion in the Nth (e.g., first) video stream, then at step 1108, server 32 identifies the object in the Nth (e.g., first) video stream. Identifying an object may comprise determining if the object is a person, an animal, or a vehicle. In some embodiments, identifying an object may comprise determining whether 1) the object is a person (e.g., a child, a young adult, an adult or a senior adult); 2) the object is a domestic animal or a wild animal and/or the animal is a bird or a terrestrial animal; or 3) the vehicle is a bicycle (including an e-bike or pedelec), a motorcycle (including a scooter), an automobile, a truck, or some other type of motorized vehicle.

At step 1110, server 32 determines object characteristics for the Nth object. If the Nth object is a person, server 32 may determine, for example, a size of the person, information about the clothes that the person is wearing, a gait (including a gait speed), and/or a direction of travel. If the Nth object is a vehicle, server 32 may determine, for example, a size of the vehicle, a vehicle signature (e.g., color, a license plate, roof rack, bike rack, tire size, etc.), a speed, and/or a direction of travel. If the Nth object is an animal, server 32 may determine, for example, a size of the animal, whether the animal is a domesticated animal (e.g., a dog or cat) or a wild animal (e.g., a fox or a coyote), a speed, and/or a direction of travel. Independent of other subsequent steps, server 32 may store information determined from steps 1104, 1106 and 1108 in memory 98.

Trend analyses may occur over hours, days, months, or years. A trend time may depend on the time needed to complete one instance of a pattern. For example, if a pattern indicates a person walks around building 910-2 and one instance typically requires 10-15 minutes, a trend time needs to be longer than 15 minutes.

At step 1112, embodiments may store the Nth (e.g., first) object characteristics (e.g., object type, object description, object speed, object direction of travel, etc.) in memory 98.

At step 1114, server 32 may set a trend period. A trend period may range from shorter periods (e.g., 5 minutes) to longer periods (e.g., weekly, monthly). For example, a trend period may be set to one hour, wherein embodiments may analyze video streams at an hour to determine how many times per hour an event occurs.

At step 1116, server 32 may increment N (e.g., increase the value of variable N to equal N+1).

At step 1118, server 32 may receive the Nth (e.g., second) video stream from the Nth (e.g., second) camera 11.

At step 1120, embodiments may determine if there is any motion in the Nth (e.g., second) video stream. In some embodiments, processor 14 in bridge 12 may determine if there is motion in the Nth (e.g., second) video stream.

If, at step 1120, processor 14 determines there is not any motion in the Nth (e.g., second) video stream, then server 32 may increment the variable N and monitor other video streams for motion.

If, at step 1120, processor 14 determines there is motion in the Nth (e.g., second) video stream, then at step 1122, embodiments may identify the object in the Nth (e.g., second) video stream. In some embodiments, processor 14 in bridge 12 executes instructions to identify the Nth (e.g., second) object. In some embodiments, processor 92 in server 32 may identify the object in the Nth (e.g., second) video stream.

At step 1124, embodiments may determine object characteristics for the Nth (e.g., second) object. In some embodiments, processor 14 in bridge 12 executes instructions to determine object characteristics for the Nth (e.g., second) object. In some embodiments, processor 92 in server 32 may determine object characteristics for the Nth (e.g., second) object.

At step 1126, embodiments may determine if the Nth (e.g., second) object is the same as an object (e.g., the first object) stored in memory 98 in data center 30. Determining if the Nth (e.g., second) object is the same as the object stored in memory 98 may comprise comparing object characteristics (e.g., object size, object appearance, object speed, object direction of travel, etc.).

If, at step 1126, embodiments determine the Nth (e.g., second) object is different from the object stored in memory 98, embodiments may stop monitoring video streams.

If, at step 1126, embodiments determine the Nth (e.g., second) object is the same as the object stored in memory, then at step 1128, embodiments may determine the object is following an individual trend.

At step 1130, server 32 may determine whether an individual trend matches a trend for another object.

If, at step 1130, server 32 determines an individual trend does not match any other individual trends, the individual trend may be stored in memory 98 and the process ends.

If, at step 1130, server 32 determines an individual trend matches one or more individual trends, then at step 1132, server 32 may store object characteristics and the individual trends as a collective trend.

Steps 1130 and 1132 may be repeated until all matching individual trends are added into a collective trend.

Steps 1114 to 1132 may be repeated each time an object is detected in a new field of view 904, wherein the process stops when embodiments determine either the trend time has ended and/or an individual trend does not match other individual trends or a collective trend.

Embodiments may advantageously track objects to determine whether a pattern matches an individual trend or a collective trend. For example, when a child wanders off, they might not follow a path that adults typically follow. Referring to FIG. 9, patterns for adults leaving building 912-1 may include them passing through fields of view 904-7 and 904-6 on their way to building 912-2 or to their cars parked in parking lot 910-1. However, a child may exit building 912-1 and travel through fields of view 904-7 or 904-6 but may turn in the direction of camera 10-2. Embodiments may determine this path is atypical, especially for a person with a small size, and send a notification to alert others (e.g., adults), including one or more video frames, a time, and an indication of the direction of travel.

### Information Handling Systems

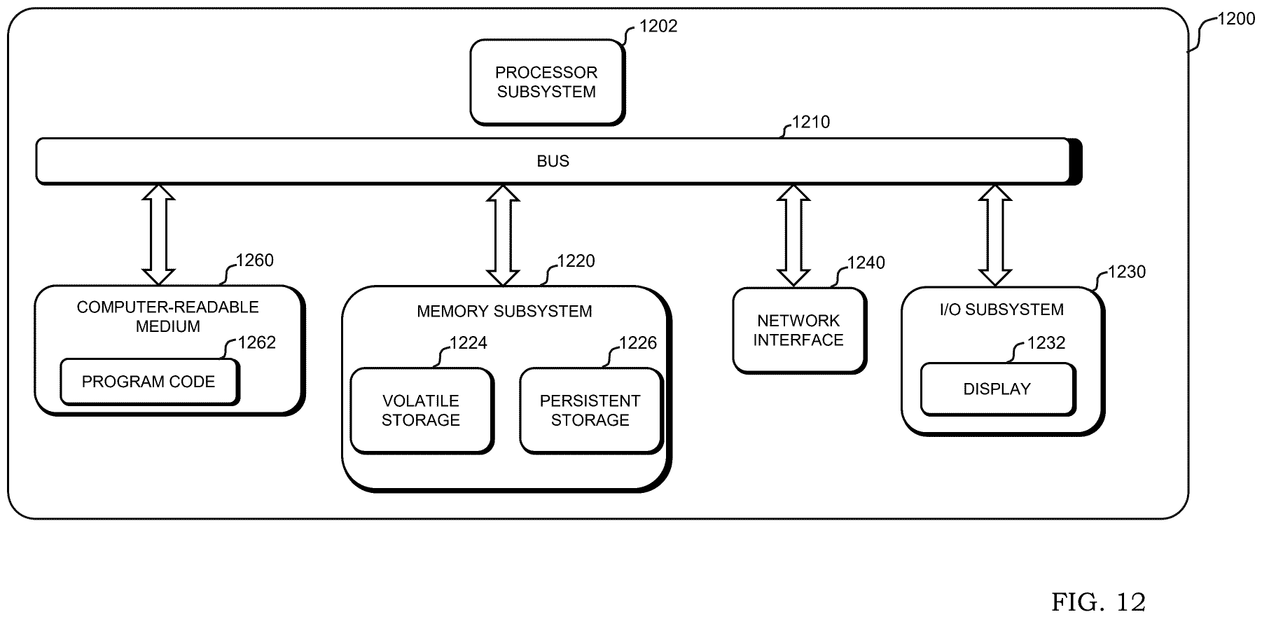

Referring to FIG. 12, data center 30, video surveillance control system 40, user system server 42, third-party monitoring system server 44, third-party analytics system 46 and third-party artificial intelligence (AI) system 48 may comprise embodiments of information handling systems 1200. FIG. 12 depicts an information handling system 1200 capable of administering several of the embodiments of the present disclosure. Information handling system 1200 may include processor subsystem 1202 communicatively coupled via system bus 1210 to memory subsystem 1220, input/output (I/O) subsystem 1230 and network interface 1240.

Processor subsystem 1202 may comprise a system, device, or apparatus operable to interpret and execute program instructions and process data, and may include a microprocessor, microcontroller, digital signal processor (DSP), application specific integrated circuit (ASIC), or another digital or analog circuitry configured to interpret and execute program instructions and process data. In some embodiments, processor subsystem 1202 may interpret and execute program instructions and process data stored locally (e.g., in memory subsystem 1220). In the same or alternative embodiments, processor subsystem 1202 may interpret and execute program instructions and process data stored remotely (e.g., in a network storage resource). Processor subsystem 1202 may include components such as a central processing unit (GPU) and a graphics processing unit (GPU).

System bus 1210 may refer to a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

Memory subsystem 1220 may comprise a system, device, or apparatus operable to retain and retrieve program instructions and data for a period (e.g., computer-readable media). Memory subsystem 1220 may comprise one or more volatile storage 1224 and persistent storage 1226. Storage may comprise random access memory (RAM), electrically erasable programmable read-only memory (EEPROM), a PCMCIA card, flash memory, magnetic storage, opto-magnetic storage or a suitable selection or array of volatile or non-volatile memory that retains data after power is removed.

I/O subsystem 1230 may comprise a system, device, or apparatus operable to receive and transmit data to or from or within information handling system 1200. I/O subsystem 1230 may represent, for example, a variety of communication interfaces, graphics interfaces, video interfaces, user input interfaces, and peripheral interfaces. In various embodiments, I/O subsystem 1230 may be used to support various peripheral devices, such as a touch panel, a display adapter, a keyboard, an accelerometer, a touch pad, a gyroscope, or a camera, among other examples. In some implementations, I/O subsystem 1230 may support so-called ‘plug and play’ connectivity to external devices, in which the external devices may be added or removed while information handling system 1200 is operating. In some embodiments, information handling system 1200 may further include display 1232. Display 1232 may be of a variety of display types, such as a liquid crystal display (LCD), an organic light emitting diode (OLED), a flat panel display, a solid-state display, or a cathode ray tube (CRT). Display 1232 may include one or more touch screen display modules and touch screen controllers for receiving user inputs to information handling system 1200. Additionally, information handling system 1200 may include an input device, such as a keyboard, and a cursor control device, such as a mouse or touchpad or similar peripheral input device.

Network interface 1240 may be a suitable system, apparatus, or device operable to serve as an interface between information handling system 1200 and a network (not shown). Network interface 1140 may enable information handling system 1200 to communicate over the network using a suitable transmission protocol or standard. In some embodiments, network interface 1240 may be communicatively coupled via the network to a network storage resource (not shown). The network coupled to network interface 1240 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or another appropriate architecture or system that facilitates the communication of signals, data and messages (generally referred to as data). The network coupled to network interface 1240 may transmit data using a desired storage or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), or any combination thereof. The network coupled to network interface 1240 or various components associated therewith may be implemented using hardware, software, or any combination thereof.

Still referring to FIG. 12, computer program product 1260 may comprise computer-readable media 1260 storing program code 1262. Program code 1262 may be loaded onto or transferred to information handling system 1200 for running by processor subsystem 1202.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures and may be implemented in general purpose and special-purpose computing systems, or other devices having processing capability. Any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Furthermore, this disclosure provides various example implementations, as described, and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

What is claimed is:

1. A method for object tracking across video frames, the method comprising:
receiving a first video stream from a first camera at a first site;
determining a first object is moving in the first video stream;
determining a first set of object characteristics for the first object;
receiving a second video stream from a second camera at a second site;
determining a second object is moving in the second video stream;
determining a second set of object characteristics for the second object; and
determining, based on the first set of object characteristics matching the second set of object characteristics, that the first object and the second object are the same object.

2. The method of claim 1, wherein determining a first set of object characteristics for the first object comprises:
determining a direction of movement of the first object in the first video stream;
determining a second set of object characteristics for the second object comprises determining a direction of movement of the second object in the second video stream; and
determining, based on the direction of movement of the first object in the first video stream and the direction of movement of the second object in the second video stream, that the first object and the second object are the same object.

3. The method of claim 2, wherein determining a first set of object characteristics for the first object comprises:
determining a speed of the first object in the first video stream;
determining a second set of object characteristics for the second object comprises determining a speed of the second object in the second video stream; and
determining, based on the speed of the first object exiting from the first video stream and the speed of the second object entering the second video stream, that the first object and the second object are the same object.

4. The method of claim 3, further comprising:
determining a distance between the first site and the second site; and
determining, based on one or more of the speed of the first object, the speed of the second object and the distance between the first site and the second site, that the first object and the second object are the same object.

5. The method of claim 4, further comprising:
determining a first camera direction for the first camera;
determining a second camera direction for the second camera; and
determining, based on one or more of the direction of travel of the first object relative to the first camera direction, the direction of travel of the second object relative to the second camera direction and the distance between the first site and the second site, that the first object and the second object are the same object.

6. A system for object tracking across video frames, the system comprising:
a first bridge comprising:
a first memory storing a first set of instructions; and
a first processor configured to execute the first set of instructions to:
receive a first video stream from a first camera at a first site;
determine a first object is moving in the first video stream;
determine a first set of object characteristics for the first object; and
communicate the first video stream to a data center;
a second bridge comprising:
a second memory storing a second set of instructions; and
a second processor configured to execute the second set of instructions to:
receive a second video stream from a second camera at a second site;
determine a second object is moving in the second video stream;
determine a second set of object characteristics for the second object; and
communicate the second video stream to the data center, wherein the data center comprises:
a third memory storing a third set of instructions; and
a third processor configured to execute the third set of instructions to:
receive the first video stream and the second video stream; and
determine, based on the first object moving, the second object moving, the first set of object characteristics and the second set of object characteristics, that the first object and the second object are the same object.

7. The system of claim 6, wherein:
one or more of the first processor and the third processor is configured to determine a direction of movement of the first object in the first video stream;
one or more of the second processor and the third processor is configured to determine a direction of movement of the second object in the second video stream; and
the third processor is configured to determine, based on the direction of movement of the first object in the first video stream and the direction of movement of the second object in the second video stream, that the first object and the second object are the same object.

8. The system of claim 7, wherein the third processor is configured to determine, based on a time between the first object exiting from the first video stream and the second object entering the second video stream, that the first object and the second object are the same object.

9. The system of claim 8, wherein:
one or more of the first processor and the third processor is configured to determine a speed of the first object;
one or more of the second processor and the third processor is configured to determine a speed of the second object; and
the third processor is configured to determine, based on one or more of the speed of the first object and the speed of the second object, that the first object and the second object are the same object.

10. The system of claim 9, wherein the third processor is configured to:
determine a distance between the first site and the second site; and
determine, based on one or more of the speed of the first object, the speed of the second object and the distance between the first site and the second site, that the first object and the second object are the same object.

11. The system of claim 10, wherein:
one or more of the first processor and the third processor is configured to determine a first camera direction for the first camera;
one or more of the second processor and the third processor is configured to determine a second camera direction for the second camera; and
the third processor is configured to determine, based on one or more of the direction of travel of the first object relative to the first camera direction, the direction of travel of the second object relative to the second camera direction and the distance between the first site and the second site, that the first object and the second object are the same object.

12. A method for determining camera nearness, the method comprising:
receiving a first video stream from a first camera at a first site;
determining a first object is moving in the first video stream;
determining a first set of object characteristics for the first object;
receiving a second video stream from a second camera at a second site;
determining a second object is moving in the second video stream;
determine a second set of object characteristics for the second object;
determining the first object and the second object are the same object; and
determining a nearness between the first site and the second site based on the first object being the same object as the second object and a time between the first object exiting the first video stream and the second object entering the second video stream.

13. The method of claim 12, further comprising:
determining a direction of movement of the first object in the first video stream;
determining a direction of movement of the second object in the second video stream; and
determining the nearness between the first site and the second site based on the direction of movement of the first object in the first video stream and the direction of movement of the second object in the second video stream.

14. The method of claim 13, further comprising:
determining, based on a time between the first object exiting from the first video stream and the second object entering the second video stream, that the first object and the second object are the same object.

15. The method of claim 14, further comprising:
determining a speed of the first object;
determining a speed of the second object; and
determining, based on one or more of the speed of the first object and the speed of the second object, that the first object and the second object are the same object.

16. The method of claim 15, further comprising:
determining a distance between the first site and the second site; and
determining, based on one or more of the speed of the first object, the speed of the second object and the distance between the first site and the second site, that the first object and the second object are the same object.

17. The method of claim 16, further comprising:
determining a first camera direction for the first camera;
determining a second camera direction for the second camera; and
determining, based on one or more of the direction of travel of the first object relative to the first camera direction, the direction of travel of the second object relative to the second camera direction and the distance between the first site and the second site, that the first object and the second object are the same object.
